(19) United States
(12) Patent Application Publication
(10) Pub. No.: US 2023/0411044 A1
(43) Pub. Date: Dec. 21, 2023

(54) DUPLEX TWISTED SHIELDED CABLE, AND WIRE HARNESS

(71) Applicant: YAZAKI CORPORATION, Tokyo (JP)

(72) Inventors: Toshiharu Shimizu, Susono-shi (JP); Takeyuki Omura, Susono-shi (JP)

(21) Appl. No.: 18/317,867

(22) Filed: May 15, 2023

(30) Foreign Application Priority Data
Jun. 20, 2022 (JP) 2022-098652

(51) Int. Cl. H01B 11/10; H01B 13/06; H01B 13/22; H01B 7/18; H01B 7/00

(52) U.S. Cl. CPC H01B 11/1033; H01B 13/06; H01B 7/0045; H01B 7/18; H01B 13/22

(57) ABSTRACT

There are provided a duplex twisted shielded cable and a wire harness, the duplex twisted shielded cable including: two insulated wires that are twisted together, each having a conductor and an insulator covering the conductor; a film wound spirally on the two insulated wires such that parts of the film overlap each other; a metal foil shield wound spirally on the film such that parts of the metal foil shield overlap each other; a metal braid provided on an outer periphery of the metal foil shield; and a sheath provided on an outer periphery of the metal braid. The film and the metal foil shield are provided as a separate member.

### CROSS-REFERENCE TO RELATED APPLICATIONS

This application is based on and claims priority under 35 USC 119 from Japanese Patent Application No. 2022-098652 filed on Jun. 20, 2022, the contents of which are incorporated herein by reference.

### TECHNICAL FIELD

The present disclosure relates to a duplex twisted shielded cable and a wire harness.

### BACKGROUND ART

In the related art, there has been proposed a duplex twisted shielded cable that is a duplex shielded cable for high-speed digital signal transmission for the purpose of improving characteristics of a leakage attenuation amount at the time when a differential signal is applied (see JP2017-183178A).

The duplex twisted shielded cable includes a twisted pair formed by twisting two insulated wires together, a metal foil shield provided around the twisted pair, a metal braid on the metal foil shield, and a sheath provided on the metal braid. A signal to be transmitted in such a duplex twisted shielded cable has a high frequency, and considering a skin effect and a return current, it is effective for the duplex twisted shielded cable to have a metal foil shield having a smooth surface.

However, in the duplex twisted shielded cable disclosed in JP2017-183178A, when the metal foil shield is wound around the two insulated wires, wrinkles are likely to occur in a gap between the two insulated wires, and a position of the metal foil shield with respect to the insulated wire is unstable, and transmission characteristics are likely to deteriorate.

### SUMMARY OF INVENTION

The present disclosure provides a duplex twisted shielded cable and a wire harness capable of suppressing deterioration of transmission characteristics.

According to an illustrative aspect of the present disclosure, a duplex twisted shielded cable includes: two insulated wires that are twisted together, each having a conductor and an insulator covering the conductor; a film wound spirally on the two insulated wires such that parts of the film overlap each other; a metal foil shield wound spirally on the film such that parts of the metal foil shield overlap each other; a metal braid provided on an outer periphery of the metal foil shield; and a sheath provided on an outer periphery of the metal braid. The film and the metal foil shield are provided as a separate member.

According to another illustrative aspect of the present disclosure, a wire harness includes: the duplex twisted shielded cable according to the above aspect 1 or 2; and another member adjacent to the duplex twisted shielded cable.

### BRIEF DESCRIPTION OF DRAWINGS

FIG. 1 is a perspective view of a wire harness including a duplex twisted shielded cable according to an embodiment of the present disclosure;

FIG. 2 is a perspective view illustrating the duplex twisted shielded cable shown in FIG. 1;

FIG. 3 is a cross-sectional view illustrating the duplex twisted shielded cable shown in FIG. 1;

FIG. 4 is a table illustrating duplex twisted shielded cables according to Examples 1 to 4 and Comparative Examples 1 and 2;

FIG. 5 is a graph illustrating LCTL of the duplex twisted shielded cables according to Examples 1, 3, and 4 and Comparative Example 2;

FIG. 6 is a graph illustrating insertion losses of the duplex twisted shielded cables according to Examples 1, 3, and 4 and Comparative Example 2;

FIG. 7A is a cross-sectional view illustrating the duplex twisted shielded cables at the time of bending according to Examples 1 to 3;

FIG. 7B is a cross-sectional view illustrating the duplex twisted shielded cable at the time of bending according to Example 4;

FIG. 8 is a graph illustrating a characteristic impedance of the duplex twisted shielded cable at the time of bending; and

FIG. 9 is a table illustrating characteristic impedances of the duplex twisted shielded cables at the time of bending.

### DESCRIPTION OF EMBODIMENTS

Hereinafter, the present disclosure will be described with reference to preferred embodiments. It should be noted that the present disclosure is not limited to the following embodiments, and modifications can be appropriately made without departing from the gist of the present disclosure. In addition, in the embodiments described below, although there are portions in which illustration and description of a part of the configuration are omitted, it is needless to say that a publicly known or well-known technique is appropriately applied to the details of the omitted technique within a range in which no contradiction with the contents described below occurs.

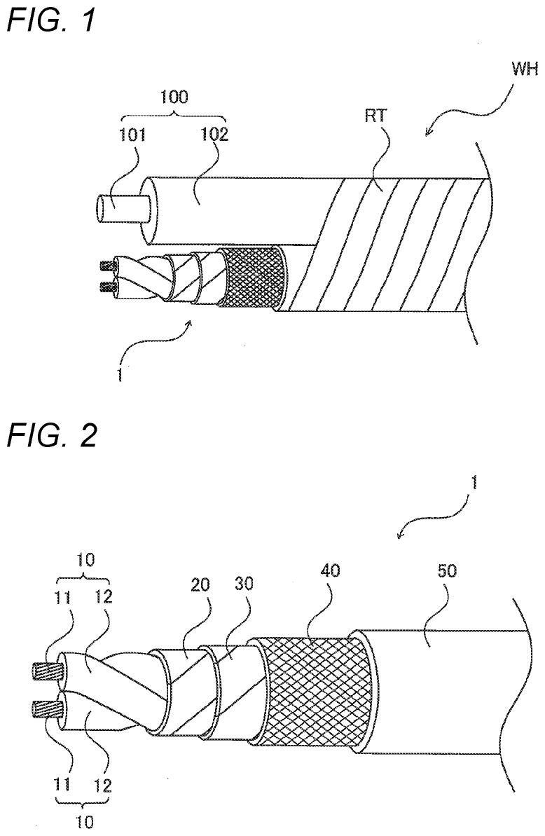

FIG. 1 is a perspective view of a wire harness including a duplex twisted shielded cable according to an embodiment of the present disclosure. As illustrated in FIG. 1, a wire harness WH includes a duplex twisted shielded cable 1 and another cable (another member) 100.

The other cable 100 is, for example, a thick electric wire such as a power line or a thin electric wire such as another signal line, and includes a conductor 101 and an insulator 102 covering a periphery of the conductor 101. A resin tape RT is wound around the duplex twisted shielded cable 1 and the other cable 100, or a corrugated tube (not shown), a terminal (not shown), a connector, or the like is attached to the duplex twisted shielded cable 1 and the other cable 100.

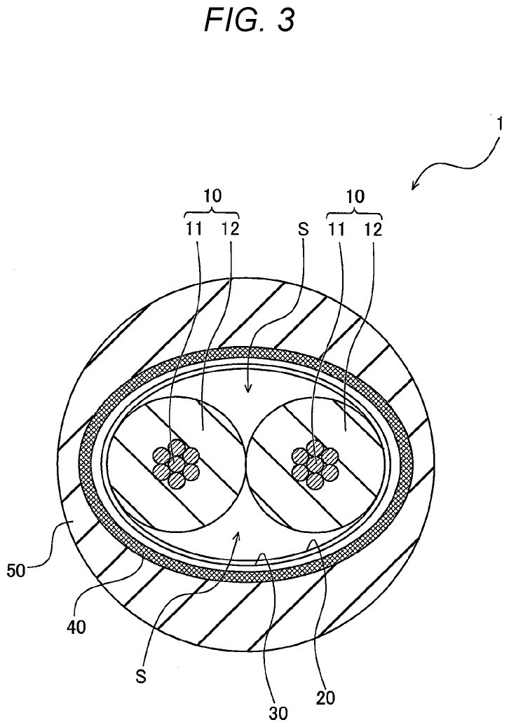

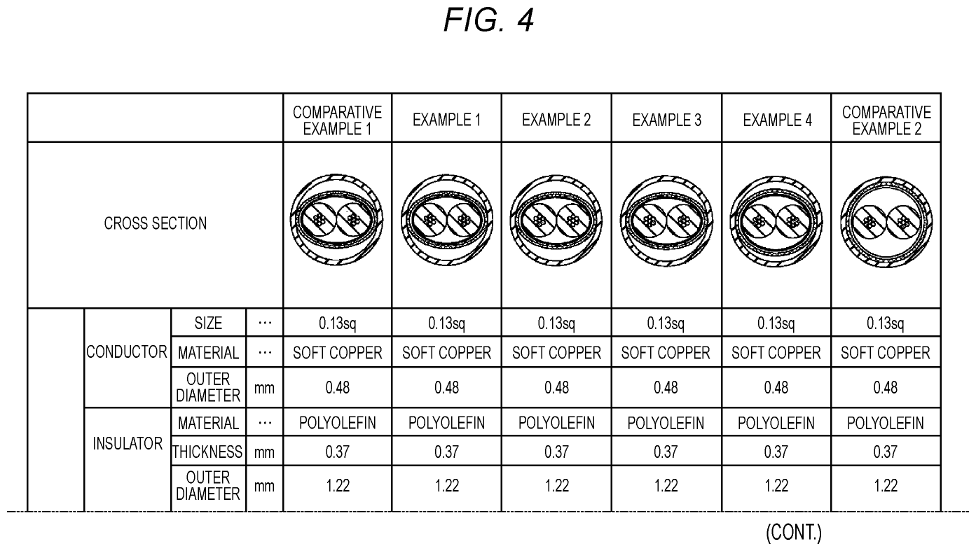

FIG. 2 is a perspective view illustrating the duplex twisted shielded cable 1 shown in FIG. 1, and FIG. 3 is a cross-sectional view illustrating the duplex twisted shielded cable 1 shown in FIG. 1. As illustrated in FIGS. 2 and 3, the duplex twisted shielded cable 1 includes two insulated wires 10, a film 20, a metal foil shield 30, a metal braid 40, and a sheath 50.

The insulated wires 10 each include a conductor 11 and an insulator 12 on the conductor 11, and are twisted so as to be helical with respect to each other. As the conductor 11, a soft copper wire, a silver-plated soft copper wire, a tin-plated soft copper wire, a tin-plated copper alloy wire, or the like is used. Although the conductor 11 is implemented by a twisted wire obtained by twisting two or more (specifically, seven) wires in the embodiment, the present disclosure is not particularly limited thereto. The conductor 11 may be implemented by one single wire. Further, although a cross-sectional area of the conductor 11 is assumed to be 0.22 sq (“sq” is a unit for indicating square millimeter) or less, the present disclosure is not particularly limited thereto.

The insulator 12 is a member covering the conductor 11. As the insulator 12, polyethylene (PE), polypropylene (PP), or the like is used. The insulator 12 has a dielectric constant of 3.0 or less.

The film 20 is a non-conductive resin film and is made of polyethylene terephthalate (PET) resin. The film 20 is wound spirally on the two insulated wires 10 and parts of the film 20 overlap each other.

The metal foil shield 30 has a three-layer structure including a film layer, an adhesive layer, and a metal layer, the adhesive layer integrally bonding the film layer and the metal layer. The metal foil shield 30 wound spirally on the film 20 and parts of the metal foil shield 30 overlap each other. The film 20 is not provided as a part of the metal foil shield 30, but is provided as a separate member.

The film layer of the metal foil shield 30 is a non-conductive resin film, and is made of, for example, PET resin. The metal layer is a conductive metal layer and is made of a metal such as copper or aluminum. From the viewpoint of ensuring shielding performance, the metal layer preferably has a thickness of 8 μm or more when made of copper, and preferably has a thickness of 10 μm or more when made of aluminum. The metal foil shield 30 is wound on the two insulated wires 10 to overlap the parts of the film 20 to each other, so that the metal layer is on an outer side.

The metal braid 40 is formed by weaving bundles of metal wires such as a soft copper wire, a silver-plated soft copper wire, a tin-plated soft copper wire, or a tin-plated copper alloy wire, each bundle including a plurality of the metal wires. The metal wire may be a plated fiber obtained by applying a metal plating on a fiber. Further, the metal braid 40 may be formed by weaving a flat bundle obtained by collectively applying a plating to a plurality of metal wires.

The sheath 50 is an insulator that covers an outer periphery of the metal braid 40. The sheath 50 is in a stuffing state on an outer peripheral side of the metal braid 40. That is, the sheath 50 is provided in a so-called solid state rather than in a tube form having a void inside. By solid extrusion with respect to a component formed of the insulated wires 10, the film 20, the metal foil shield 30, and the metal braid 40, the sheath 50 is provided around the insulated wires 10, the film 20, the metal foil shield 30, and the metal braid 40. The sheath 50 is made of, for example, PE, PP, and polyvinyl chloride (PVC). The sheath 50 is not limited to the solid state, and may be implemented in a tube shape and disposed in a state in which a void is provided at some parts with respect to the inner metal braid 40, or any other inclusion may be separately provided in the void.

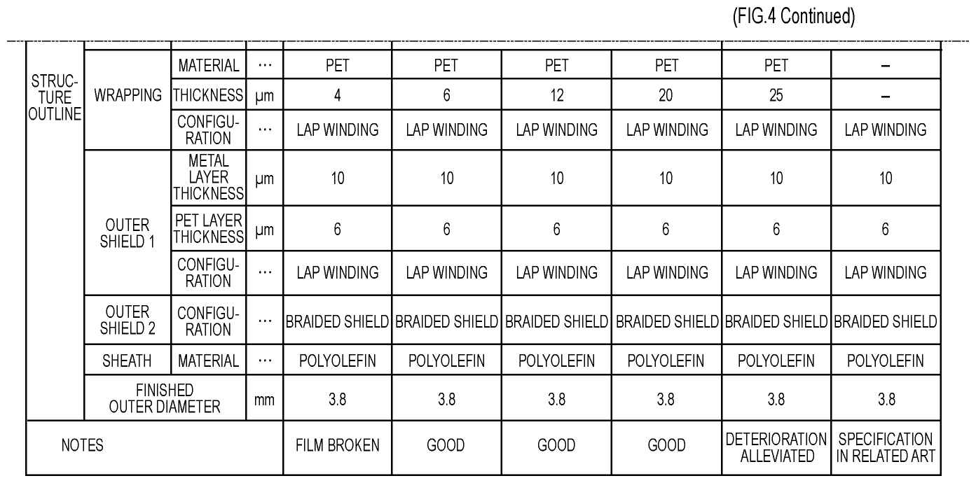

Next, examples and comparative examples of the duplex twisted shielded cable 1 according to the embodiment will be described. FIG. 4 is a table illustrating duplex twisted shielded cables according to Examples 1 to 4 and Comparative Examples 1 and 2. In the duplex twisted shielded cables according to Examples 1 to 4 and Comparative Examples 1 and 2, a conductor was a twisted wire formed by twisting seven soft copper wires together, and had a cross-sectional area of 0.13 sq and an outer diameter of 0.48 mm. An insulator was made of polyolefin having a thickness of 0.37 mm, and had an outer diameter of 1.22 mm as a result of covering the conductor.

An outer shield 1 was formed of a metal foil shield, in which a thickness of a metal layer was 10 μm and a thickness of a film layer was 6 μm, and was provided by winding the metal foil shield with respect to two insulated wires. An outer shield 2 was formed of a braided shield formed of a metal wire. A sheath was made of polyolefin. With the above configuration, the duplex twisted shielded cables according to Examples 1 to 4 and Comparative Examples 1 and 2 had a finished outer diameter of 3.8 mm.

A film serving as a wrapping member was made of the PET resin, and a thickness thereof was 4 μm in Comparative Example 1, 6 μm in Example 1, 12 μm in Example 2, 20 μm in Example 3, and 25 μm in Example 4. The wrapping member is used by winding the wrapping member. In Comparative Example 2, the film serving as a wrapping member was not used.

In Comparative Example 1, since the film was actually broken due to being too thin, it was not possible to manufacture the duplex twisted shielded cable having the film.

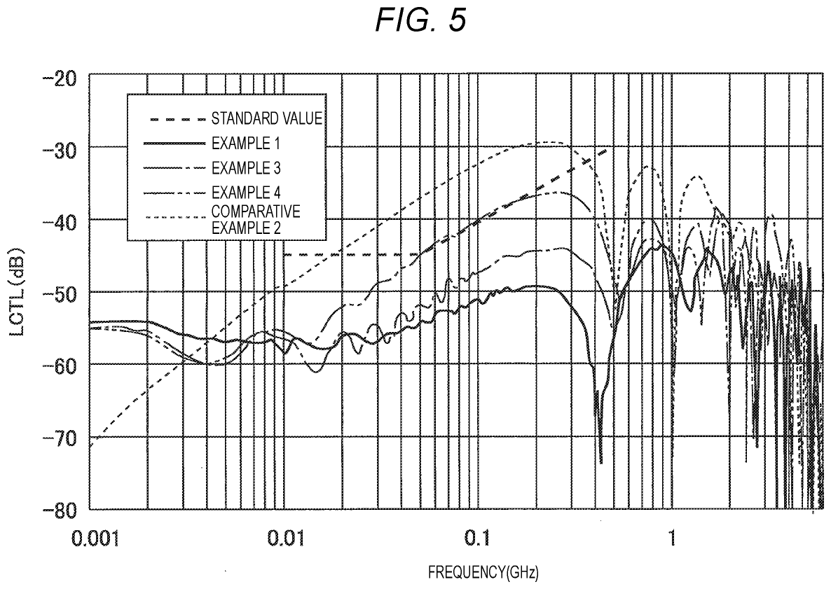

FIG. 5 is a graph illustrating long conversion transfer losses (LCTL) of the duplex twisted shielded cables according to Examples 1, 3, and 4 and Comparative Example 2. As illustrated in FIG. 5, regarding Examples 1 and 3, a result was shown that a standard value was satisfied in the entire frequency range from 0.01 GHz to 0.5 GHz. Regarding Example 4, the standard value was not satisfied in some frequency ranges but was satisfied in the remaining majority of frequency ranges, and it was found that Example 4 was usable depending on a frequency band of a signal to be received and transmitted. In contrast, regarding Comparative Example 2, a result was shown that the standard value was not satisfied in a range from less than 0.05 GHz to less than about 0.4 GHz. This is because the duplex twisted shielded cable according to Comparative Example 2 did not have a film and a position of the metal foil shield was unstable. Although Example 2 was not illustrated, an intermediate result between those of Example 1 and Example 3 was confirmed.

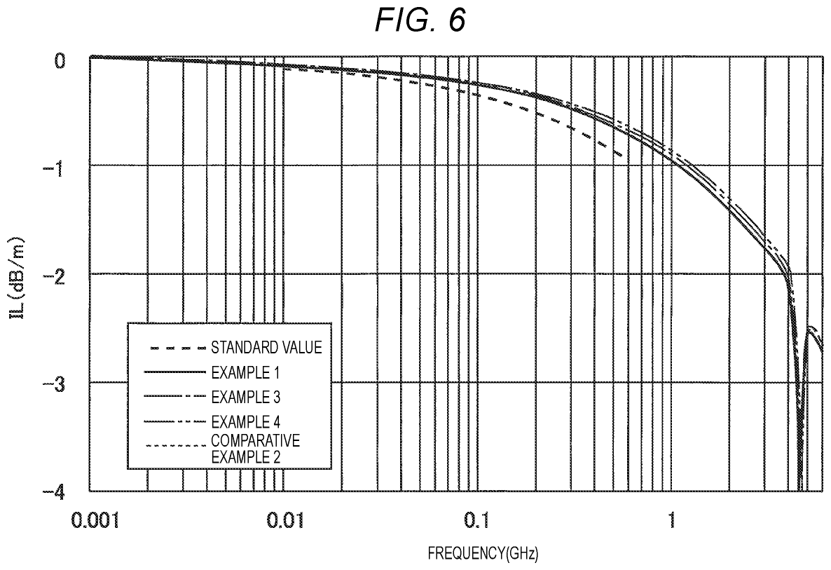

FIG. 6 is a graph illustrating insertion losses of the duplex twisted shielded cables according to Examples 1, 3, and 4 and Comparative Example 2. As illustrated in FIG. 6, regarding the insertion loss, a standard value was satisfied in all of Examples 1, 3, and 4 and Comparative Example 2. Regarding Example 2 that was not illustrated, an intermediate result between Example 1 and Example 3 was obtained similarly to the above.

Further, although not illustrated, the duplex twisted shielded cables according to Examples 1 to 4 and Comparative Example 2 satisfied standard values for the characteristic impedance and the reflection loss. Accordingly, it was found that the duplex twisted shielded cables according to Examples 1 to 4 were superior to the duplex twisted shielded cable according to Comparative Example 2 in LCTL, and had good transmission characteristics. Furthermore, it was found that the duplex twisted shielded cables according to Examples 1 to 3, in which the thickness of the film was 6 μm or more and 20 μm or less, were superior to the duplex twisted shielded cable according to Example 4, in which the thickness of the film was m, in terms of LCTL, and had better transmission characteristics.

In addition, it was found that the duplex twisted shielded cables according to Examples 1 to 3 were superior to the duplex twisted shielded cable according to Example 4 in the characteristic impedance at the time of cable bending.

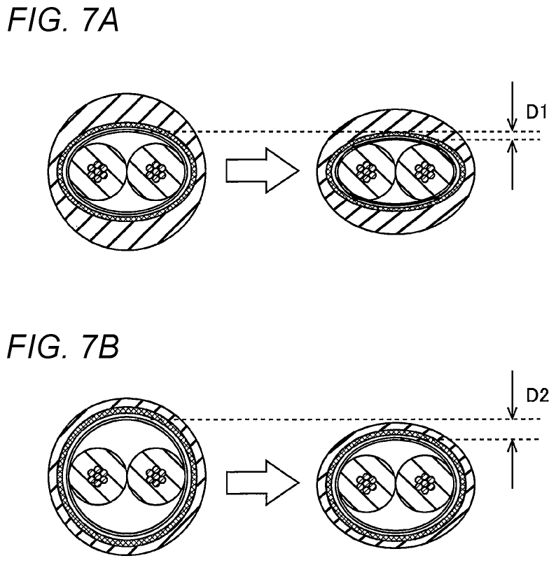

FIG. 7A is a cross-sectional view illustrating the duplex twisted shielded cables at the time of bending according to Examples 1 to 3. FIG. 7B is a cross-sectional view illustrating the duplex twisted shielded cable at the time of bending according to Example 4.

The duplex twisted shielded cable shown in FIG. 7A has a film of 20 μm or less. Therefore, the film is relatively thin, and is wound around the two insulated wires in a state where an ellipticity in value is small. When such a duplex twisted shielded cable is bent in an elliptical short-axis direction, the duplex twisted shielded cable is flattened, and a distance between the metal foil shield and the two insulated wires is reduced by D1.

On the other hand, the duplex twisted shielded cable shown in FIG. 7B has a film thickness of 25 μm. Therefore, the film is relatively thick, and is wound around the two insulated wires in a state where an ellipticity in value is large. When such a duplex twisted shielded cable is bent in the elliptical short-axis direction, the duplex twisted shielded cable is flattened, and a distance between the metal foil shield and the two insulated wires is reduced by D2 (>D1).

As described above, in the duplex twisted shielded cable having a thick film, a change in the distance between the metal foil shield and the two insulated wires is large at the time of bending, and the transmission characteristics are easily deteriorated.

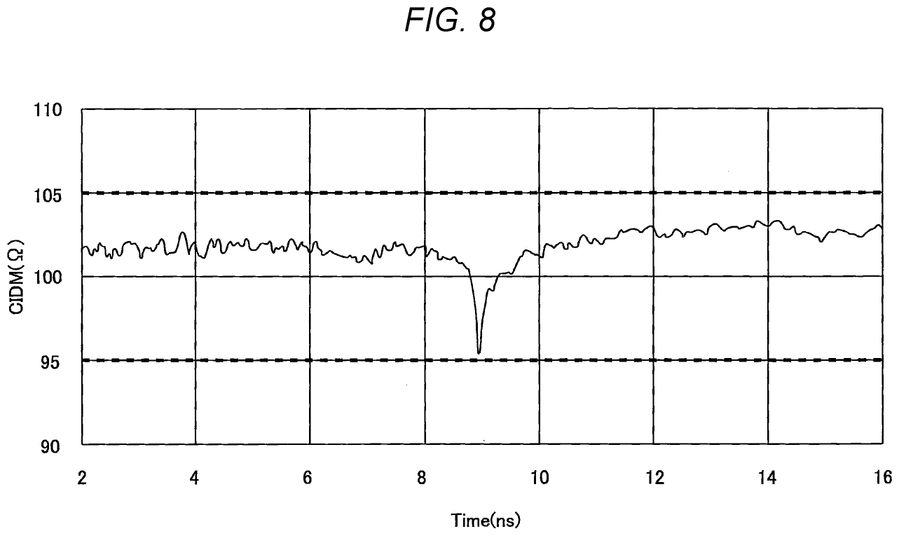

FIG. 8 is a graph illustrating a characteristic impedance of the duplex twisted shielded cable at the time of bending. In FIG. 8, broken lines indicate standard values. As illustrated in FIG. 8, in a case where a bent portion is present, the distance between the metal foil shield and the two insulated wires changes, and therefore, as shown at a time-point of 9 ns, the characteristic impedance decreases to the vicinity of a characteristic impedance standard value (95Ω). Here, in the example illustrated in FIG. 8, the characteristic impedance does not fall outside the standard value, but when the amount of change in the distance between the metal foil shield and the two insulated wires increases, the characteristic impedance may fall outside the standard value.

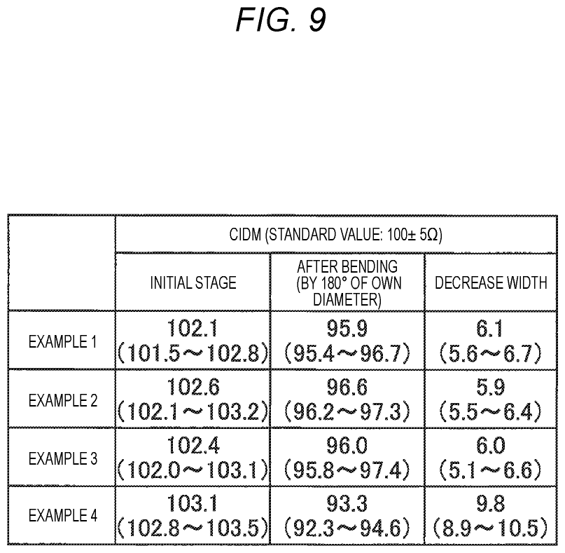

FIG. 9 is a table illustrating characteristic impedances of the duplex twisted shielded cables at the time of bending. First, in the table shown in FIG. 9, in a column of initial stage, a result of measuring the characteristic impedance of the duplex twisted shielded cable in a straight state is shown, with the number of samples being five. Similarly, in a column of after bending (by 1800 of own diameter), a result of measuring the characteristic impedance when bending by 180° is performed with a cable outer diameter as the diameter is shown, with the number of samples being five. A decrease width indicates a difference between the results. Numerical values in parentheses indicate a minimum value and a maximum value, and a numerical value outside the parentheses indicate a median value. Further, the bending by 180° of own diameter is assumed to be a worst condition in mounting on a vehicle.

As illustrated in FIG. 9, regarding Examples 1 to 3, the decrease width is about 6Ω, and the characteristic impedance does not fall below 95Ω, which is the standard value, even after bending. On the other hand, in Example 4, the decrease width reaches 9.8Ω, and the characteristic impedance falls below the standard value of 95Ω after bending. Therefore, regarding the characteristic impedance at the time of cable bending, it was found that the duplex twisted shielded cables according to Examples 1 to 3 were superior to the duplex twisted shielded cable according to Example 4.

In this way, the duplex twisted shielded cable 1 of the embodiment includes the film 20 wound spirally on the two insulated wires 10 to overlap the parts of the film 20 to each other and the metal foil shield 30 wound spirally on the film 20 to overlap the parts of the metal foil shield 30 to each other, and the film 20 and the metal foil shield 30 are provided as a separate member. As described above, since the film 20 and the metal foil shield 30, which are provided as a separate member, are each wound spirally to overlap the parts of the film 20 and the parts of the metal foil shield 30, respectively, it is possible to wind the film 20 and the metal foil shield 30 without causing wrinkles even in a space S (see FIG. 3) between the two insulated wires 10 because of a characteristic of a spiral winding and overlapping of the parts. In addition, since the metal foil shield 30 is wound in a state where the film 20 exists at an inner side, the metal foil shield 30 is wound in a state where the space S between the two insulated wires 10 is filled with the film 20. Accordingly, the occurrence of wrinkles in the metal foil shield 30 is further suppressed, and the position of the metal foil shield 30 with respect to the two insulated wires 10 can be easily stabilized. Accordingly, it is possible to provide the duplex twisted shielded cable 1 capable of suppressing deterioration of the transmission characteristics.

In addition, since the thickness of the film 20 is a range of 6 μm or more and 20 μm or less, it is possible to easily prevent breakage at the time of manufacturing the duplex twisted shielded cable 1 and to easily satisfy a standard value (of June in 2022).

In addition, according to the wire harness WH of the embodiment, it is possible to provide the wire harness WH capable of suppressing deterioration of transmission characteristics.

Although the present disclosure has been described above based on the embodiments, the present disclosure is not limited to the above embodiments. Modifications may be made without departing from the gist of the present disclosure and publicly known or well-known techniques may be appropriately combined.

For example, although the metal foil shield 30 is disposed such that the metal layer faces an outer side in the duplex twisted shielded cable 1 in the above-described embodiments, the present disclosure is not limited thereto, and the metal foil shield 30 may face an inner side.

In addition, in the duplex twisted shielded cable 1 according to the embodiment, it is assumed that the metal braid 40 is attached to a shielded connector. Alternatively, the attachment target may not be a shielded connector.

According to an aspect 1 of the present disclosure, a duplex twisted shielded cable (1) includes: two insulated wires (10) that are twisted together, each having a conductor (11) and an insulator (12) covering the conductor (11); a film (20) wound spirally on the two insulated wires (10) such that parts of the film (20) overlap each other; a metal foil shield (30) wound spirally on the film (20) such that parts of the metal foil shield (30) overlap each other; a metal braid (40) provided on an outer periphery of the metal foil shield (30); and a sheath (50) provided on an outer periphery of the metal braid (40). The film (20) and the metal foil shield (30) are provided as a separate member.

According to an aspect 2 of the present disclosure, the film (20) may have a thickness of 6 μm or more and 20 μm or less.

According to an aspect 3 of the present disclosure, a wire harness (WH) may include: the duplex twisted shielded cable (1) according to the aspect 1 or 2; and another member (100) adjacent to the duplex twisted shielded cable (1).

According to the present disclosure, it is possible to provide a duplex twisted shielded cable and a wire harness capable of suppressing deterioration of transmission characteristics.

What is claimed is:

1. A duplex twisted shielded cable comprising:
two insulated wires that are twisted together, each having a conductor and an insulator covering the conductor;
a film wound spirally on the two insulated wires such that parts of the film overlap each other;
a metal foil shield wound spirally on the film such that parts of the metal foil shield overlap each other;
a metal braid provided on an outer periphery of the metal foil shield; and
a sheath provided on an outer periphery of the metal braid, wherein
the film and the metal foil shield are provided as a separate member.

2. The duplex twisted shielded cable according to claim 1, wherein the film has a thickness of 6 μm or more and 20 μm or less.

3. A wire harness comprising:
the duplex twisted shielded cable according to claim 1; and
another member adjacent to the duplex twisted shielded cable.
